(19) United States
(12) Patent Application Publication
(10) Pub. No.: US 2009/0098403 A1
(43) Pub. Date: Apr. 16, 2009

(54) Low alloy steel for oil country tubular goods and seamless steel pipe

(76) Inventors: Tomohiko Omura, Osaka (JP); Yuji Arai, Amagasaki-shi (JP); Kuniaki Tomomatsu, Wakayama-shi (JP); Toshiharu Abe, Osaka (JP)

Correspondence Address: CLARK & BRODY, 1090 VERMONT AVENUE, NW, SUITE 250, WASHINGTON, DC, 20005, US

(21) Appl. No.: 12/232,363

(22) Filed: Sep. 16, 2008

Related U.S. Application Data
(63) Continuation of application No. PCT/JP2008/056119, filed on Mar. 28, 2008.

(30) Foreign Application Priority Data
Mar. 30, 2007 (JP) 2007-092938

(51) Int. Cl. C22C 38/22; C22C 38/12; C22C 38/04; B32B 1/08

(52) U.S. Cl. 428/586; 420/84; 420/106; 420/110; 420/121

(57) ABSTRACT

A low alloy steel is provided for oil country tubular goods with a yield strength between 654 MPa and 757 MPa, and possessing excellent resistance to HIC and SSC in high-pressure hydrogen sulfides environment, and comprising, by mass %: 0.10 to 0.60% C; 0.05 to 0.5% Si; 0.05 to 3.0% Mn; 0.025% or less P; 0.010% or less S; 0.005 to 0.10% Al; 0.01% or less O (oxygen); 3.0% or less Cr; and 3.0% or less Mo, wherein the amount of Cr and Mo content is 1.2% or more, with the balance being Fe and impurities, and the number of nonmetallic inclusions whose major axis is 10 μm or more is 10 per square millimeter in the inspected cross section. The present invention provides a low alloy steel for oil country tubular goods possessing excellent resistance to sulfide stress cracking, and a seamless steel pipe.

The disclosure of Japan Patent Application No. 2007-092938 filed Mar. 30, 2007 including specification, drawings and claims is incorporated herein by reference in its entirety.

### TECHNICAL FIELD

The present invention relates to a low alloy steel for oil country tubular goods used in environments containing hydrogen sulfide such as oil wells and gas wells, and a seamless steel pipe made from that steel.

### BACKGROUND ART

In oil wells and gas wells, oil country tubular goods of 80 ksi grade (YS: 551 to 654 MPa) have been normally used but because of even deeper oil wells, an even stronger types of oil country tubular goods is needed. Therefore, in recent years 95 ksi grade (YS: 654 to 758 MPa) and 110 ksi grade (YS: 758 to 861 MPa) oil country tubular goods are increasingly being used.

On the other hand, shallow wells with a low corrosion atmosphere have been drying up, so deep wells with highly corrosive atmosphere containing high-pressure hydrogen sulfide at 2 atm or more have often been developed in recent years. Oil country tubular goods used in such environments, must possess high strength, and there is the further problem of hydrogen embrittlement referred to as hydrogen induced cracking (HIC) and sulfide stress cracking (SSC). The greatest challenge in producing oil country tubular goods is therefore obtaining high strength and resolving the problem of HIC and SSC.

Although, a high Ni-base alloy has been utilized for oil country tubular goods used in environments containing high-pressure hydrogen sulfide, low-alloy oil country tubular goods are required in order to reduce developing costs.

Methods for preventing HIC and SSC in low-alloy oil country tubular goods include methods for making highly purified steel, methods for converting the steel structure into fine grains, etc. The applicant has already proposed a method to improve SSC resistance by limiting nonmetallic inclusions to a specific size (patent documents 1 and 2). However, it is assumed that conventional low-alloy oil country tubular goods only be used in environments containing hydrogen sulfide at 1 atm or less.

In patent document 1, the applicant proposed a method to improve SSC resistance by reducing nonmetallic inclusions of 20 μm or more along the major axis, and in patent document 2 proposed a method to improve SSC resistance by reducing nitrides of 5 μm or more along the major axis. However, all evaluation results shown in these patent documents are for hydrogen sulfide environments at 1 atm or less.

Non-patent document 1 shows that when steel containing B, M₂₃C₆ (M: Fe, Cr, Mo) has a Cr content of 1% or more, then coarse carbide will selectively form at the prior austenite grain boundary, causing SSC of inter-granular fracture type. This document also shows SSC due to this coarse carbide occurs in hydrogen sulfide environments of 1 atm or less.

The TM0284-2003 method and TM0177-2006 method specified by National Association of Corrosion Engineers (NACE) have been adopted here as methods for evaluating corrosion from hydrogen sulfide in low-alloy oil country tubular goods. These methods evaluate HIC and SSC in acid NaCl solution saturated with hydrogen sulfide gas at 1 atm and do not assume a high pressure hydrogen sulfide environment.

Though not an example of low-alloy oil country tubular goods, non-patent document 2 discloses an example of a common line pipe steel with a yield strength (YS) in the 70 ksi grade and evaluates the HIC mechanism in high-pressure hydrogen sulfide environments. Non-patent document 2 indicates that the risk of HIC increases at a hydrogen sulfide pressure of 2 to 5 atm, but that HIC does not easily occur at a hydrogen sulfide pressure of 15 atm.

However a low-alloy oil country tubular goods possesses higher strength than the line pipe of non-patent document 2. Even though there is an increased risk of HIC and SSC in the same environment, no study has been made on a chemical composition of low alloy for oil country tubular goods that assumes usage in a high-pressure hydrogen sulfide environment. Therefore up to now, there has been no attempt to find a method to prevent HIC and SSC in low-alloy oil country tubular goods in a high hydrogen sulfide environment.

[Patent document 1] Japanese Unexamined JP 2001-172739 A

[Patent document 2] Japanese Unexamined JP 2001-131698 A

[Non-patent document 1] M. Ueda et. al, Proc. Int. Conf Corrosion 2005, Houston, 2005, Paper No. 05089

[Non-patent document 2] M. Kimura et. al, Proc. Int. Conf Corrosion 85, Massachusetts, 1985, Paper No. 237

### DISCLOSURE OF THE INVENTION

### Problems to be Solved by the Invention

Resistance to SSC can be enhanced in low-alloy oil country tubular goods used in low-pressure hydrogen sulfide environments by improving the internal microstructure of the steel by the above described methods such as high purification and grain refinement. However, HIC and SSC can only be prevented to a limited extent in low-alloy oil country tubular goods used in even more highly corrosive hydrogen sulfide environments at high pressure (specifically 2 atm or more). There is also a limit on to what extent HIC and SSC can be prevented just by improving the internal microstructure of steel by methods such as high purification and grain refinement.

The present inventors therefore made various studies to improve protection performance against corrosive substances in high-pressure highly corrosive hydrogen sulfide environments by further enhancing HIC and SSC resistance.

In wet environments containing hydrogen sulfide, the hydrogen sulfide accelerates the penetration of hydrogen into the steel. The HIC and SSC which are one type of hydrogen embrittlement occur due to this hydrogen penetration. The greater the amount of hydrogen sulfide in an environment, the larger the effect created by the hydrogen sulfide. Namely, the effect of the hydrogen sulfide becomes larger as the partial pressure of hydrogen sulfide becomes higher in the environment, increasing the risk of HIC and SSC.

Coatings generated by corrosion, such as sulfide, oxide, generally function as a barrier to hydrogen penetration. In environments containing corrosion hydrogen sulfide, iron sulfide as a corrosion product is generated on the surface of steel. However sulfide generally has low density compared to oxide. Sulfide is therefore not considered to offer sufficient protection against hydrogen penetration and is also considered one cause of HIC and SSC. However, in wet environments containing hydrogen sulfide, generation of iron sulfide is dominant while little iron oxide is generated.

The inventors considered that an optimal molybdenum (Mo) and chromium (Cr) content in the base material would generate insoluble oxides better than iron and generate a denser oxide film coating that would offer better protection against corrosive byproducts.

An object of the present invention is to provide a low alloy steel and a seamless steel pipe, with high strength for oil country tubular goods and having excellent HIC resistance and SSC resistance even in high-pressure hydrogen sulfide environments. A high pressure hydrogen sulfide environment here indicates an environment containing hydrogen sulfide at 2 atm or more; and high strength here indicates a yield strength (YS) of 95 ksi

### Means for Solving the Problems

The present invention is intended to solve the aforementioned problems. A brief summary for the low alloy steel for oil country tubular goods is shown in the following (1) and (2), and a summary of the seamless steel pipe is shown in the following (3).

(1) A low alloy steel for oil country tubular goods with a yield strength between 654 MPa and 757 MPa possessing excellent HIC resistance and SSC resistance in a high-pressure hydrogen sulfide environment comprising, by mass %: 0.10 to 0.60% C; 0.05 to 0.5% Si; 0.05 to 3.0% Mn; 0.025% or less P; 0.010% or less S; 0.005 to 0.10% Al; 0.01% or less O (oxygen); 3.0% or less Cr; and 3.0% or less Mo, and characterized in that the amount of Cr and Mo is 1.2% or more, with the balance being Fe and impurities, and the number of nonmetallic inclusions that are 10 μm or more along an inspection cross section of 1 square millimeter is 10 or less.

The low alloy steel for oil country tubular goods described in (1) further preferably comprises, at least one selected from the group consisting by mass % of, 0.0003 to 0.003% B, 0.002 to 0.1% Nb, 0.002 to 0.1% Ti, 0.002 to 0.1% Zr, and 0.003 to 0.03% N. Alternatively, the low alloy steel for oil country tubular goods may further preferably comprise 0.05 to 0.3% V and/or 0.0003 to 0.01% Ca.

(2) A low alloy steel for oil country tubular goods with a yield strength of 758 MPa or more, comprising by mass %: 0.10 to 0.60% C; 0.05 to 0.5% Si; 0.05 to 3.0% Mn; 0.025% or less P; 0.010% or less S; 0.005 to 0.10% Al; 0.01% or less O (oxygen); 3.0% or less Cr; 3.0% or less Mo; and 0.05 to 0.3% V, wherein the contents of Cr and Mo satisfy the relationship: Cr+3Mo≧2.7%, with the balance being Fe and impurities, and the number of nonmetallic inclusions 10 μm or more along an inspection cross section of 1 square millimeter is 10 or less.

The low alloy steel for oil country tubular goods described in (2) preferably further comprises, at least one element selected from the group consisting by mass % of, 0.0003 to 0.003% B, 0.002 to 0.1% Nb, 0.002 to 0.1% Ti, 0.002 to 0.1% Zr, and 0.003 to 0.03% N. The low alloy steel for oil country tubular goods is even more preferably comprised of 0.0003 to 0.01% Ca.

A seamless steel pipe made from the steel described in (1) or (2).

### EFFECT OF THE INVENTION

The high-strength, low alloy steel for oil country tubular goods and the seamless steel pipe of the present invention provide excellent resistance to HIC and SSC and are therefore ideal for use in high pressure hydrogen sulfide environments.

### BEST MODE FOR CARRYING OUT THE INVENTION

(A) Chemical Composition of the Steel

C: 0.10 to 0.60%

Carbon (or C) is effective for enhancing hardenability and improving strength. To obtain this effect, the C content must be 0.10% or more. On the other hand, when the C content is higher than 0.60%, the effect is saturated, so 0.60% is set as the upper limit. The lower limit is preferably 0.25%. The upper limit is preferably 0.40%.

Si: 0.05 to 0.5%

Silicon (or Si) is an effective element for deoxidizing the steel, and also enhances resistance to softening during tempering. To achieve deoxidization, the Si content must be 0.05% or more. On the other hand, when the Si content exceeds 0.5%, precipitation in the ferrite phase is accelerated, which is soft and lowers resistance to SSC. The Si content is therefore set in a range from 0.05 to 0.5%. The lower limit is preferably 0.10%. The upper limit is preferably 0.35%.

Mn: 0.05 to 3.0%

Manganese (or Mn) is an effective element for ensuring the hardenability of the steel. To ensure hardenability the Mn content must be 0.05% or more. On the other hand, when the Mn content is more than 3.0%, the Mn is segregated together with impurity elements such as P and S in the grain boundary, which lowers the SSC resistance. The Mn content was therefore set from 0.05 to 3.0%. The lower limit is preferably 0.30%. The upper limit is preferably 0.50%.

P: 0.025% or less

Phosphorus (or P) is segregated into the grain boundary to lower SSC resistance. However this effect becomes drastic when the SSC content exceeds 0.025%, so the upper limit was set to 0.025%. The P is preferably limited to 0.015% or less.

S: 0.010% or less

Sulfur (or S) segregates in the grain boundary in the same way as P, which lowers the SSC resistance. However this effect becomes drastic when the S content exceeds 0.010%, so the upper limit was set to 0.010%. The S content is preferably limited to 0.003% or less.

Al: 0.005 to 0.10%

Aluminum (or Al) is an effective element for deoxidizing steel. However this effect cannot be obtained when the content is below 0.005%. On the other hand, when the Al content is 0.10% or more then the effect is saturated, so the upper limit was set to 0.10%. The Al content of the present invention denotes that of acid-soluble Al (so called “sol. Al”). The lower limit is preferably 0.020%. The upper limit is preferably 0.050%.

O (oxygen): 0.01% or less

Oxygen (or oxygen) is present in steel as an impurity, and when the content exceeds 0.01%, it forms a coarse oxide, which lowers toughness and SSC resistance. The upper limit was therefore set to 0.01%. The oxygen (or O) content is preferably 0.001% or less.

Cr: 3.0% or less, Mo: 3.0% or less

Cr and Mo are elements that prevent penetration of hydrogen into the steel and improve SSC resistance by forming a dense oxide layer on the surface of the oil country tubular goods. These effects are exhibited when the Cr+Mo is 1.2% or more for 95 ksi grade (YS: 654 to 758 MPa) steel, and when the Cr+3Mo is 2.7% or more for 110 ksi grade (YS: 758 to 861 MPa) steel. To stabilize this effect, the Cr content is preferably 1.0% or more, and more preferably 1.2% or more. On the other hand, since these effects are saturated when the Cr and Mo is excessive, the upper limit for both Cr and Mo was set to 3.0%.

The Mo must also be higher for 110 ksi grade steel than for 95 ksi grade steel because Mo not only renders the effect of improving resistance to corrosion but also enhances the tempering temperature and improves SSC resistance by forming a fine carbide together with V.

V: 0.05 to 0.3% (essential for 110 ksi grade; arbitrary for 95 ksi grade)

Vanadium (or V) has the effect of generating a fine carbide, MC (M: V and Mo), and enhancing the tempering temperature. To achieve these effects, the V content must be at least 0.05% to prevent SSC in 110 ksi grade steel products. Vanadium (V) need not be used in 95 ksi grade steel, but may be used when the above-described effects are needed. When the V content is more than 0.3%, the V in solid solution saturates during quenching, and the effect that enhances the tempering temperature also saturates. The V upper limit was therefore set to 0.3%.

B: 0.0003% to 0.003%

Boron (or B) is not always essential but is effective for improving the hardenability of the steel. On the other hand, when an excessive boron content accelerates the generation of a coarse grain boundary carbide M₂₃C₆ (M: Fe, Cr, Mo), resulting in lower SSC resistance. The B content is therefore preferably 0.0003 to 0.003%. In addition, N (nitrogen) is preferably fixed as a nitride other than boron nitride (BN), in order to obtain an adequate effect from B. Therefore, Ti or Zr, which generates nitride easer than B, is preferably added to steel containing B.

Nb: 0.002 to 0.1%

Ti: 0.002 to 0.1%

Zr: 0.002 to 0.1%

Nb, Ti and Zr all combine with C and N to form carbonitride which works effectively for grain refinement by a pinning effect, and improves mechanical characteristics such as toughness. To obtain this effect, the content of each element is preferably 0.002% or more. On the other hand, since the effect saturates when the content is more than 0.1%, an upper limit of 0.1% is set.

N: 0.003 to 0.03%

Although nitrogen (or N) is present in steel as an unavoidable impurity, when contained in a favorable manner, it may combine along with C in Al, Nb, Ti or Zr to form carbonitride, which works effectively to refine grain by a pinning effect and improves mechanical characteristics such as toughness. To obtain this effect, the N content is preferably 0.003% or more. On the other hand, since the effect saturates when the content is more than 0.03%, the upper limit is preferably 0.03%.

Ca: 0.0003 to 0.01%

Calcium (or Ca) combines with S in steel to form sulfide, and enhances the SSC resistance by improving the shape of inclusions. To obtain this effect, the Ca content is preferably 0.0003% or more. On the other hand, since this effect saturates when more the content is more than 0.01%, the upper limit is preferably 0.01%.

(B) Nonmetallic Inclusions

In severe environments containing hydrogen sulfide at high pressure, merely improving the protection from corrosive product films from Cr and Mo as described above does not offer adequate production from corrosion. Therefore, nonmetallic inclusions which serve as an initiation site for HIC must be reduced to a greater extent than achieved up until now. The HIC that occurs in low alloy steel for oil well usually begins as a nonmetal inclusion within the steel product. Therefore, among all nonmetallic inclusions including not only nitrides but also oxysulfides which tend to coarsen, those of 10 mm or more along the major axis must be reduced as much as possible. HIC tends to easily occur in particular, when there are more than 10 nonmetallic inclusions present whose major axis is 10 μm or more. The number of pieces with a cross section less than one square millimeter must therefore be reduced to 10 pieces or less.

Methods for reducing nonmetallic inclusions, include a method that reduces as much as possible the Ti, N (nitrogen), O (oxygen) and S that easily form coarse inclusions; a method that floats off coarse inclusions by heating molten steel with a heater or stirring it; and a method that prevents oxide from the refractory of the furnace wall from mixing in while melting, etc. The inclusions are normally generated just after melting, and often become larger during cooling, so generation of coarse inclusions can be prevented by increasing the cooling rate just after melting. Generation of coarse inclusions for example can be prevented by setting the cooling rate to 100° C./min or more in a temperature range of 1500 to 1200° C. (temperature of outermost layer of steel ingot, and the same hereafter) just after melting. Moreover, when the S, N and O (oxygen) are suppressed respectively to 0.003% or less, 0.005% or less, and 0.001% or less, the cooling rate in a temperature range of 1500 to 1200° C. just after melting may be made less than 100° C. per minute.

(C) Production Method

There are no particular restrictions on the production process after melting. In the case of plate material for example, after producing a steel ingot by the conventional method, a steel product may then be produced by methods such as hot forging and hot rolling. Seamless steel pipe may also be produced by conventional methods. Heat treatment is preferably performed because quenching and tempering treatment provides excellent SSC resistance. Quenching is preferably performed at temperatures of 900° C. or higher in order to sufficiently solutionize carbide-generating elements such as Cr, Mo and V. In the cooling step during quenching, water cooling is preferable when the C (carbon) content is 0.3% or less, and oil cooling or shower cooling is preferable when C content is more than 0.3%, in order to prevent quenching cracks.

### EXAMPLES

Hereinafter, in order to verify the effect of the present invention, steel with a chemical composition shown in Tables 1 and 2 was melted, and the various types of performance were evaluated. The steels A to B, steels L to O, steels P to T, steels d to e, and steels w to aa, billet were prepared after melting, and made into a seamless steel pipe through piercing and rolling. In the other steels, blocks 40 mm thick each were sampled by hot forging, and these blocks were made to a thickness of 12 mm by hot rolling to form a plate material.

The cooling rate after manufacture in a temperature range from 1500 to 1200° C. was set to 20° C./min for steels A and B, 100° C./min for steels C and D, and 500° C./min for steels E to K. Additionally, for steels A and B, the S, N and O (oxygen) were respectively suppressed to a content of 0.003% or less, 0.005% or less, and 0.001% or less. In steels L to O and steels d and e, the cooling rate was set to 150° C./min, and for steels a to c and steels f to v, the cooling rate was set to 500° C./min. In all steels P to T and steels w to aa, the cooling rate was set to 50° C./min in a temperature range from 1500 to 1200° C. just after melting. In the steels P to T and steels w to aa, at least one of the conditions of S: 0.003% or less, N: 0.005% or less, and O (oxygen): 0.001% or less was not satisfied.

TABLE 1

| | Chemical composition (mass %, balance: Fe and impurities) | | | | | | | | | | | | | | | | |
|---|---|---|---|---|---|---|---|---|---|---|---|---|---|---|---|---|---|
| Steel | C | Si | Mn | P | S | Cr | Mo | Nb | Ti | Al | N | V | B | Ca | O | Zr | Cr + Mo |
| A | 0.27 | 0.28 | 0.46 | 0.006 | 0.001 | 1.05 | 0.71 | 0.031 | 0.015 | 0.056 | 0.005 | 0.10 | 0.0014 | — | 0.0006 | — | 1.76 |
| B | 0.25 | 0.29 | 0.82 | 0.011 | 0.003 | 1.11 | 0.33 | — | 0.007 | 0.051 | 0.004 | — | — | 0.0012 | 0.0010 | — | 1.44 |
| C | 0.28 | 0.21 | 0.45 | 0.010 | 0.001 | 0.00 | 1.48 | 0.040 | 0.016 | 0.032 | 0.005 | 0.10 | 0.0010 | — | 0.0015 | — | 1.48 |
| D | 0.27 | 0.20 | 0.45 | 0.011 | 0.002 | 0.00 | 1.92 | 0.028 | 0.014 | 0.036 | 0.004 | 0.10 | 0.0010 | — | 0.0021 | — | 1.92 |
| E | 0.40 | 0.11 | 0.39 | 0.011 | 0.006 | 1.22 | 0.99 | 0.031 | 0.015 | 0.030 | 0.015 | 0.05 | — | — | 0.0018 | — | 2.21 |
| F | 0.29 | 0.19 | 0.43 | 0.012 | 0.001 | 0.98 | 0.70 | 0.031 | 0.015 | 0.032 | 0.004 | — | 0.0011 | — | 0.0018 | — | 1.68 |
| G | 0.27 | 0.28 | 0.50 | 0.001 | 0.001 | 0.52 | 0.70 | 0.032 | 0.014 | 0.034 | 0.003 | 0.10 | 0.0003 | — | 0.0020 | — | 1.22 |
| H | 0.38 | 0.10 | 0.39 | 0.008 | 0.005 | 1.25 | 0.16 | 0.025 | 0.014 | 0.036 | 0.011 | 0.05 | — | — | 0.0013 | — | 1.41 |
| I | 0.27 | 0.20 | 0.45 | 0.008 | 0.001 | 1.25 | 0.70 | 0.015 | — | 0.030 | 0.004 | 0.10 | — | — | 0.0018 | — | 1.95 |
| J | 0.27 | 0.20 | 0.80 | 0.008 | 0.001 | 1.25 | 0.70 | 0.015 | — | 0.030 | 0.004 | 0.10 | — | — | 0.0019 | — | 1.95 |
| K | 0.37 | 0.11 | 0.38 | 0.009 | 0.004 | 1.21 | 0.68 | 0.029 | 0.015 | 0.034 | 0.004 | 0.05 | — | — | 0.0013 | 0.051 | 1.89 |
| L | 0.26 | 0.18 | 0.57 | 0.007 | 0.003 | 0.56 | 0.30 | — | 0.013 | 0.031 | 0.005 | 0.05 | 0.0015 | 0.0007 | 0.0013 | — | 0.86* |
| M | 0.24 | 0.35 | 1.34 | 0.012 | 0.005 | 0.20 | 0.01 | — | 0.008 | 0.058 | 0.005 | — | — | 0.0021 | 0.0008 | — | 0.21* |
| N | 0.18 | 0.21 | 0.76 | 0.009 | 0.005 | 0.30 | 0.49 | — | 0.015 | 0.027 | 0.006 | 0.05 | 0.0014 | 0.0020 | 0.0042 | — | 0.79* |
| O | 0.29 | 0.29 | 0.48 | 0.001 | 0.001 | 0.50 | 0.30 | 0.031 | 0.013 | 0.030 | 0.001 | — | — | — | 0.0016 | — | 0.80* |
| P | 0.23 | 0.27 | 0.72 | 0.016 | 0.004 | 0.96 | 0.16 | — | 0.024 | 0.040 | 0.006 | — | 0.0012 | — | 0.0014 | — | 1.12 |
| Q | 0.24 | 0.26 | 0.40 | 0.006 | 0.001 | 0.99 | 0.69 | 0.026 | 0.010 | 0.053 | 0.010 | 0.08 | 0.0011 | — | 0.0020 | — | 1.68 |
| R | 0.26 | 0.24 | 0.43 | 0.009 | 0.005 | 0.98 | 0.45 | 0.026 | 0.026 | 0.070 | 0.005 | — | 0.0012 | — | 0.0015 | — | 1.43 |
| S | 0.25 | 0.28 | 0.45 | 0.007 | 0.001 | 1.00 | 0.68 | 0.026 | 0.012 | 0.073 | 0.008 | — | 0.0011 | — | 0.0013 | — | 1.68 |
| T | 0.23 | 0.22 | 0.44 | 0.006 | 0.001 | 0.47 | 0.69 | 0.024 | 0.019 | 0.028 | 0.003 | — | 0.0011 | — | 0.0012 | — | 1.16 |

*indicates a figure outside the range specified by the invention

TABLE 2

| | Chemical composition (mass %, balance: Fe and impurities) | | | | | | | | | | | | | | | | |
|---|---|---|---|---|---|---|---|---|---|---|---|---|---|---|---|---|---|
| Steel | C | Si | Mn | P | S | Cr | Mo | Nb | Ti | Al | N | V | B | Ca | O | Zr | Cr + 3Mo |
| a | 0.30 | 0.19 | 0.44 | 0.010 | 0.001 | 0.00 | 0.99 | — | 0.015 | 0.033 | 0.004 | 0.19 | 0.0013 | — | 0.0015 | — | 2.97 |
| b | 0.27 | 0.20 | 0.45 | 0.011 | 0.002 | 0.00 | 1.92 | 0.028 | 0.014 | 0.036 | 0.004 | 0.10 | 0.0010 | — | 0.0021 | — | 5.76 |
| c | 0.40 | 0.11 | 0.39 | 0.011 | 0.006 | 1.22 | 0.99 | 0.031 | 0.015 | 0.030 | 0.015 | 0.24 | — | — | 0.0018 | — | 4.19 |
| d | 0.39 | 0.13 | 0.45 | 0.007 | 0.008 | 1.32 | 0.75 | 0.018 | 0.014 | 0.025 | 0.012 | 0.24 | — | — | 0.0022 | — | 3.57 |
| e | 0.26 | 0.20 | 0.45 | 0.008 | 0.001 | 0.98 | 0.69 | 0.030 | 0.014 | 0.034 | 0.004 | 0.10 | 0.0009 | — | 0.0023 | — | 3.05 |
| f | 0.28 | 0.21 | 0.45 | 0.010 | 0.001 | 0.00 | 1.48 | 0.040 | 0.016 | 0.032 | 0.005 | 0.10 | 0.0010 | — | 0.0031 | — | 4.44 |
| g | 0.27 | 0.20 | 0.45 | 0.013 | 0.003 | 0.00 | 2.47 | 0.031 | 0.021 | 0.028 | 0.004 | 0.10 | 0.0010 | — | 0.0090 | — | 7.41 |
| h | 0.38 | 0.21 | 0.47 | 0.008 | 0.001 | 1.25 | 0.72 | 0.033 | — | 0.021 | 0.010 | 0.10 | — | — | 0.0011 | — | 3.41 |
| i | 0.48 | 0.20 | 0.44 | 0.007 | 0.001 | 1.01 | 0.68 | 0.034 | — | 0.034 | 0.011 | 0.09 | — | — | 0.0015 | — | 3.05 |
| j | 0.27 | 0.20 | 0.45 | 0.008 | 0.001 | 1.25 | 0.70 | 0.015 | — | 0.030 | 0.004 | 0.10 | — | — | 0.0018 | — | 3.35 |
| k | 0.27 | 0.20 | 0.80 | 0.008 | 0.001 | 1.25 | 0.70 | 0.015 | — | 0.030 | 0.004 | 0.10 | — | — | 0.0019 | — | 3.35 |
| l | 0.28 | 0.19 | 0.44 | 0.010 | 0.001 | 0.20 | 1.02 | — | 0.015 | 0.033 | 0.004 | 0.19 | 0.0011 | — | 0.0014 | — | 3.26 |
| m | 0.37 | 0.11 | 0.38 | 0.009 | 0.004 | 1.21 | 0.68 | 0.029 | 0.015 | 0.034 | 0.004 | 0.24 | — | — | 0.0013 | 0.051 | 3.25 |
| n | 0.39 | 0.10 | 0.41 | 0.009 | 0.006 | 1.27 | 1.02 | 0.031 | 0.015 | 0.033 | 0.011 | 0.25 | — | 0.0021 | 0.0016 | — | 4.33 |
| o | 0.28 | 0.20 | 0.44 | 0.009 | 0.001 | 0.49 | 0.69 | 0.030 | 0.015 | 0.033 | 0.004 | 0.10 | 0.0010 | — | 0.0017 | — | 2.56* |
| p | 0.38 | 0.10 | 0.39 | 0.008 | 0.005 | 1.25 | 0.16 | 0.025 | 0.014 | 0.036 | 0.011 | 0.23 | — | — | 0.0013 | — | 1.73* |
| q | 0.26 | 0.20 | 0.44 | 0.008 | 0.001 | 0.49 | 0.50 | — | 0.015 | 0.029 | 0.004 | 0.19 | 0.0010 | — | 0.0015 | — | 1.99* |
| r | 0.28 | 0.19 | 0.44 | 0.010 | 0.001 | 0.49 | 0.50 | — | 0.015 | 0.032 | 0.004 | 0.10 | 0.0011 | — | 0.0016 | — | 1.99* |
| s | 0.27 | 0.19 | 0.44 | 0.010 | 0.001 | 0.20 | 0.70 | — | 0.015 | 0.032 | 0.004 | 0.19 | 0.0011 | — | 0.0013 | — | 2.3* |
| t | 0.29 | 0.29 | 0.48 | 0.001 | 0.001 | 0.50 | 0.30 | 0.031 | 0.013 | 0.030 | 0.001 | 0.20 | — | — | 0.0016 | — | 1.40* |
| u | 0.27 | 0.20 | 0.44 | 0.006 | 0.001 | 0.50 | 0.31 | 0.031 | 0.014 | 0.032 | 0.005 | 0.09 | 0.0008 | — | 0.0015 | — | 1.43* |
| v | 0.29 | 0.19 | 0.43 | 0.012 | 0.001 | 0.98 | 0.70 | 0.031 | 0.015 | 0.032 | 0.004 | —* | 0.0011 | — | 0.0018 | — | 3.08 |
| w | 0.26 | 0.24 | 0.43 | 0.009 | 0.005 | 0.98 | 0.45 | 0.026 | 0.026 | 0.070 | 0.005 | —* | 0.0012 | — | 0.0015 | — | 2.33* |
| x | 0.23 | 0.27 | 0.72 | 0.016 | 0.004 | 0.96 | 0.16 | — | 0.024 | 0.040 | 0.006 | —* | 0.0012 | — | 0.0014 | — | 1.44* |
| y | 0.25 | 0.28 | 0.45 | 0.007 | 0.001 | 1.00 | 0.68 | 0.026 | 0.012 | 0.073 | 0.008 | —* | 0.0011 | — | 0.0013 | — | 3.04 |
| z | 0.23 | 0.22 | 0.44 | 0.006 | 0.001 | 0.47 | 0.69 | 0.024 | 0.019 | 0.028 | 0.003 | —* | 0.0011 | — | 0.0012 | — | 2.54* |
| aa | 0.24 | 0.26 | 0.40 | 0.006 | 0.001 | 0.99 | 0.69 | 0.026 | 0.010 | 0.053 | 0.010 | 0.08 | 0.0011 | — | 0.0020 | — | 3.06 |

*indicates a figure outside the range specified by the invention

These seamless steel pipes and plate materials were subjected to quenching comprising maintaining at a temperature of 900 to 920° C. and subsequent water cooling, and then subjected to tempering comprising maintaining the temperature at 500 to 720° C. and subsequent air cooling. The steel grades described in Table 1 were all adjusted for a yield strength (YS) of 95 to 110 ksi (654 to 758 MPa), and the steel grades described in Table 2 were all adjusted for a yield strength (YS) of 110 to 125 ksi (758 to 861 MPa).

<Hydrogen Sulfide Corrosion Test>

Corrosion tests at 5 atm, 10 atm and 15 atm in a high-pressure hydrogen sulfide environment were performed by the following method. A stress corrosion test piece of 2 mm thick, 10 mm wide and 75 mm long was sampled from each test material. By applying a specified amount of strain to the test piece by 4-point bending in accordance with a method specified in ASTM-G39, a stress that was 90% of the yield stress was applied. After the test piece in this state was put in an autoclave along with the test jig, 5% degassed NaCl solution was poured in the autoclave leaving a vapor phase portion. The hydrogen sulfide gas of 5 atm, 10 atm or 15 atm was then charged under pressurization into the autoclave, and this high-pressure hydrogen sulfide gas was saturated in the liquid phase by stirring while in the liquid phase. After the autoclave was sealed, it was kept at 25° C. for 720 hours while stirring the liquid, the pressure was then lowered and the test piece removed.

A corrosion test in a hydrogen sulfide environment at 1 atm was performed by the following method. The above-described 4-point bending test piece was immersed in 5% NaCl with saturated hydrogen sulfide at 1 atm in room temperature in a plus 0.5% acetic acid aqueous solution (bath specified by NACE TM0177-2006 method) for 720 hours, and the test piece was then removed.

The test piece was examined after the test by naked eye for crack-generating states. Those test pieces where cracks were difficult to determine by the naked eye were buried in an epoxy resin, and cracks then identified by microscopic observation of the cross section. In the tables and the figures, test pieces where no cracks were generated are shown with a “o”, and those where cracks were generated as shown with a “x.”

<Amount of Nonmetallic Inclusion>

A test piece of 1 cm×1 cm×1 cm was cut from the test material, and after being buried in an epoxy resin, a cross section perpendicular to the rolling direction was polished, and observed at a magnitude of 100 times, and the number of nonmetallic inclusions with a major diameter of 10 μm or more per square millimeter were measured. Five views of each test material were observed, and their average numbers were compared.

Table 3 shows test results of a steel material of YS 95 ksi grade in a hydrogen sulfide environment of 10 atm. Table 4 shows test results from a steel material of YS 110 ksi grade in a hydrogen sulfide environment at 1 to 15 atm.

TABLE 3

| | | YS | Number of | |
|---|---|---|---|---|
| Classification | Steel | (MPa) | inclusions | Evaluation |
| Example 1 | A | 721 | 8.8 | ∘ |
| Example 2 | B | 734 | 7.6 | ∘ |
| Example 3 | C | 732 | 0.0 | ∘ |
| Example 4 | D | 737 | 0.0 | ∘ |
| Example 5 | E | 695 | 1.8 | ∘ |
| Example 6 | F | 695 | 0.6 | ∘ |
| Example 7 | G | 757 | 0.0 | ∘ |
| Example 8 | H | 693 | 0.4 | ∘ |
| Example 9 | I | 720 | 0.0 | ∘ |
| Example 10 | J | 713 | 0.0 | ∘ |
| Example 11 | K | 720 | 0.4 | ∘ |
| Comparative example 1 | L* | 694 | 6.0 | x |
| Comparative example 2 | M* | 721 | 8.2 | x |
| Comparative example 3 | N* | 719 | 6.8 | x |
| Comparative example 4 | O* | 713 | 0.0 | x |
| Comparative example 5 | P | 727 | 14.2* | x |
| Comparative example 6 | Q | 713 | 13.6* | x |
| Comparative example 7 | R | 734 | 16.2* | x |
| Comparative example 8 | S | 741 | 11.8* | x |
| Comparative example 9 | T | 727 | 12.8* | x |

*indicates a figure outside the range specified by the invention

TABLE 4

| | | YS | Number of | Evaluation | | | |
|---|---|---|---|---|---|---|---|
| Classification | Steel | (MPa) | inclusions | 1 atm | 5 atm | 10 atm | 15 atm |
| Example 12 | a | 848 | 0.6 | ∘ | ∘ | ∘ | ∘ |
| Example 13 | b | 806 | 0.0 | ∘ | ∘ | ∘ | ∘ |
| Example 14 | c | 832 | 1.8 | ∘ | ∘ | ∘ | ∘ |
| Example 15 | d | 855 | 7.0 | ∘ | ∘ | ∘ | ∘ |
| Example 16 | e | 841 | 0.0 | x | ∘ | ∘ | ∘ |
| Example 17 | f | 843 | 0.2 | ∘ | ∘ | ∘ | ∘ |
| Example 18 | g | 843 | 0.0 | ∘ | ∘ | ∘ | ∘ |
| Example 19 | h | 860 | 0.4 | ∘ | ∘ | ∘ | ∘ |
| Example 20 | i | 843 | 0.4 | ∘ | ∘ | ∘ | ∘ |
| Example 21 | j | 858 | 0.0 | ∘ | ∘ | ∘ | ∘ |
| Example 22 | k | 851 | 0.0 | ∘ | ∘ | ∘ | ∘ |
| Example 23 | l | 801 | 0.0 | ∘ | ∘ | ∘ | ∘ |
| Example 24 | m | 837 | 6.8 | ∘ | ∘ | ∘ | ∘ |
| Example 25 | n | 830 | 0.0 | ∘ | ∘ | ∘ | ∘ |
| Comparative example 10 | o* | 825 | 0.0 | ∘ | ∘ | x | ∘ |
| Comparative example 11 | p* | 831 | 0.4 | x | x | x | ∘ |
| Comparative example 12 | q* | 860 | 0.0 | ∘ | ∘ | x | ∘ |
| Comparative example 13 | r* | 802 | 0.0 | ∘ | ∘ | x | ∘ |
| Comparative example 14 | s* | 826 | 0.0 | ∘ | ∘ | x | ∘ |
| Comparative example 15 | t* | 796 | 0.0 | ∘ | x | x | ∘ |
| Comparative example 16 | u* | 796 | 0.0 | ∘ | x | x | ∘ |
| Comparative example 17 | v* | 833 | 0.6 | x | x | x | ∘ |
| Comparative example 18 | w* | 803 | 16.2* | x | x | x | ∘ |
| Comparative example 19 | x* | 796 | 14.2* | x | x | x | ∘ |
| Comparative example 20 | y* | 810 | 11.8* | x | x | x | ∘ |
| Comparative example 21 | z* | 796 | 12.8* | x | x | x | ∘ |
| Comparative example 22 | aa | 851 | 13.6* | x | x | x | ∘ |

*indicates a figure outside the range specified by the invention

FIG. 1 is a diagram in which crack characteristics in hydrogen sulfide tests of 10 atm for steels A to P in Table 1 (Examples 1 to 11, and Comparative examples 1 to 5) were arranged by their Cr and Mo content. As shown in Table 1, Table 3 and FIG. 1, cracks can be prevented when the amount of Cr and Mo content is 1.2% or more. This corresponds to Examples 1 to 11 (steels A to K) in Table 3. On the other hand, when the amount of Cr and Mo content was less than 1.2%, cracks were generated in the Comparative examples 1 to 5 (steels L to P)

The crack states in Comparative examples 1 to 4 were due to HIC whereby the cracks were generated and developed horizontally in the rolling direction of material, and nonmetallic inclusions of 3 to 10 μm were observed at the HIC initiation site. On the other hand, cracks were generated in the Comparative examples 5 to 9 (steels P to T) even though they have almost the same Cr and Mo content as steels A to K. The Comparative examples 5 to 9 had more nonmetallic inclusions with a major diameter of 10 μm than the other steel grades, and the cracks were HIC whose initiation sites were nonmetallic inclusions with a major diameter of 10 μm or more.

FIG. 2 is a diagram in which crack characteristics in hydrogen sulfide tests of 10 atm for steels a to u in Table 2 (Examples 12 to 25, and Comparative examples 10 to 16) were arranged by the Cr and Mo content. As shown in Table 2, Table 4 and FIG. 2, in Comparative examples 10 to 16 (steels o to u) cracks were generated in cases where “Cr+3Mo” was less than 2.7%. In this case, the cracks are from SSC which is generated and developed vertically from the surface of steel product to the stress-loaded direction, and do not start from a particularly coarse inclusion. In contrast, although cracks were generated at a hydrogen sulfide pressure at 1 atm in Example 16, no cracks were generated in any of the 5 atm, 10 atm or 15 atm cases. In other Examples 12 to 15, and 17 to 25, no cracks were generated at any hydrogen sulfide pressure.

Also as shown in Table 4, even in cases not satisfying the chemical composition specified by the present invention, there are examples exhibiting excellent resistance to HIC and SSC at 1 atm. However, at a hydrogen sulfide pressure of 10 atm which is the most severe corrosion environment, cracks were generated in the steels o to aa where the conditions of the present invention were not satisfied. On the other hand, when hydrogen sulfide pressure reached 15 atm, no cracks were generated in any of the examples. Hence, it can be concluded that the steel wherein no cracks were generated at a hydrogen sulfide pressure of 10 atm is applicable to high pressure hydrogen sulfide environments.

In steel with low content of V, SSC occurred regardless of the Cr or Mo content the same as the steels v to z in Table 4. A possible reason is that steels containing V, such as the steels a to o can be tempered at high temperature, and so the SSC resistance is improved by decreasing the dislocation density and spheroidizing the carbide, whereas steels with low V content can be tempered only at a low temperature, and so resistance to SSC was inadequate for high strength steels with a yield strength of YS 110 ksi grade. Further, cracks were generated in steels w to aa in Table 2 even though these possess almost the same Cr and Mo content as steels a to n. Cross sectional observation showed that the steels w to aa had more nonmetallic inclusions with a major diameter of 10 μm than other steel grades and the cracks were HIC whose initiation sites were nonmetallic inclusions with a major diameter of 10 μm or more.

Test results at a hydrogen sulfide pressure of 1 atm showed that SSC occurred in steel containing Cr of 1% or more and also containing B (steel e, steel v), and that no SSC occurred in steel with Cr content of less than 1% (steels q to u). Namely, it is known that cases where the hydrogen sulfide pressure at 1 atm differs completely from cases at a hydrogen sulfide pressure of 10 atm are due to the material. These results therefore clearly shows that material design concepts for preventing HIC and SSC in high pressure hydrogen sulfide environments currently being studied are different from those at conventional hydrogen sulfide environments at 1 atm or less.

FIG. 3 is a view showing the element density distribution in cross sections containing corrosion byproducts in the steel e test piece in Table 2. FIG. 3 (a) is an external view made by SEM, and (b) through (f) are results of composition analysis of the O, S, Cr, Fe and Mo made by EPMA (Electron Probe Micro Analysis). As shown in FIG. 3 (a), corrosion byproducts were formed in a dual layer on the surface of base material, with an outer layer of iron sulfide and an inner layer of oxysulfide containing Cr and Mo. After generating an outer layer of iron sulfide, the Cr and Mo is thought to generate oxide in the boundary face between base material and the sulfide outer layer where the hydrogen sulfide concentration was low, and this dense inner layer oxide enhances the protection provided by the coating, and suppresses penetration of hydrogen, thereby improving resistance to SSC.

Table 5 shows comparisons of corrosion rate for steel A, steel D, steel G and steel K of Table 1 after immersion test in hydrogen sulfide at 10 atm. The corrosion rate was found by dividing the difference in weights in the test pieces from before and after tests of the 4-point bending test by the total test piece surface area. Additionally, all steels of the present invention were steel in which no HIC and SSC occurred.

TABLE 5

| Steel | Cr content (mass %) | Corrosion rate (g/m²/h) |
|---|---|---|
| A | 1.05 | 0.5 |
| D | 0.00 | 0.8 |
| G | 0.52 | 0.8 |
| K | 1.21 | 0.4 |

As shown in Table 5, in the corrosion rates in steel A (1.05%) and steel K (1.21%) possessing a large Cr content, the coating provided high protection and corrosion was suppressed compared to the steel D (0.00%) and steel G (0.52%) where the Cr content was small. These results shows that the Cr content is preferably 1.0% and even more preferably 1.2% for obtaining stable suppression of corrosion caused by HIC and SSC.

Although only some exemplary embodiments of this invention have been described in detail above, those skilled in the art will readily appreciated that many modifications are possible in the exemplary embodiments without materially departing from the novel teachings and advantages of this invention. Accordingly, all such modifications are intended to be included within the scope of this invention.

### INDUSTRIAL APPLICABILITY

The low alloy steel for oil country tubular goods and the seamless steel pipe of the present invention though possessing high strength, also provide excellent resistance to hydrogen induced cracking (HIC) and sulfide stress cracking (SSC). The low alloy steel and seamless steel pipe of this invention are therefore ideal for oil country tubular goods materials used in high pressure hydrogen sulfide environments.

### BRIEF DESCRIPTION OF THE DRAWINGS

FIG. 1 is a diagram showing crack characteristics hydrogen sulfide tests at 10 atm for steels A to P in Table 1 arranged by their Cr and Mo content.

FIG. 2 is a diagram showing crack characteristics in hydrogen sulfide tests at 10 atm for steels a to u in Table 2 arranged by their Cr and Mo content

FIG. 3 shows the element density distribution in cross sections of corrosion byproduct in test piece of steel e in Table 2.

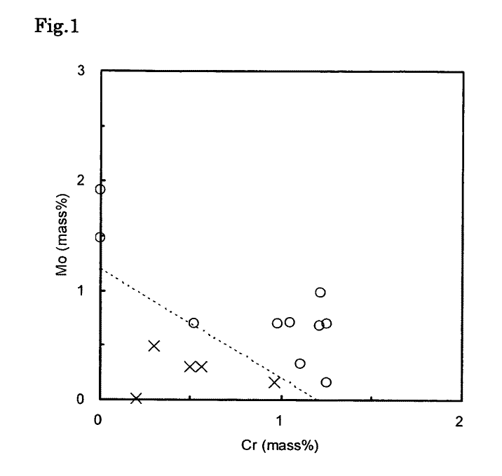

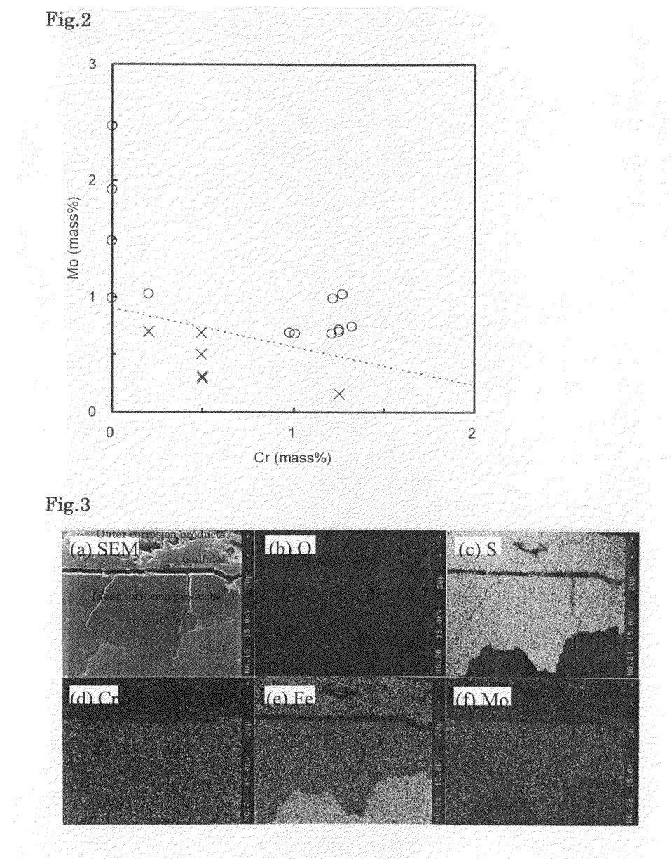

1. A low alloy steel for oil country tubular goods with a yield strength between 654 MPa and 757 MPa and excellent resistance to HIC and SSC in high-pressure hydrogen sulfide environments, and comprising by mass %:
0.10 to 0.60% C;
0.05 to 0.5% Si;
0.05 to 3.0% Mn;
0.025% or less P;
0.010% or less S;
0.005 to 0.10% Al;
0.01% or less O (oxygen);
3.0% or less Cr; and
3.0% or less Mo,
wherein the amount of Cr and Mo content is 1.2% or more, with the balance being Fe and impurities, and the number of nonmetallic inclusions whose major axis is 10 μm or more is within 10 pieces per square millimeter in the inspected cross section.

2. The low alloy steel for oil country tubular goods according to claim 1, further comprising, at least one element selected from the group consisting, by mass % of:
0.0003 to 0.003% B,
0.002 to 0.1% Nb,
0.002 to 0.1% Ti,
0.002 to 0.1% Zr, and
0.003 to 0.03% N.

3. The low alloy steel for oil country tubular goods according to claim 1, further comprising 0.05 to 0.3% V by mass %.

4. The low alloy steel for oil country tubular goods according to claim 2, further comprising 0.05 to 0.3% V by mass %.

5. The low alloy steel for oil country tubular goods according to claim 1, further comprising 0.0003 to 0.01% Ca by mass %.

6. A low alloy steel for oil country tubular goods with a yield strength of 758 MPa or more, possessing excellent resistance to HIC and SSC in high-pressure hydrogen sulfide environments, and comprising by mass %:
0.10 to 0.60% C;
0.05 to 0.5% Si;
0.05 to 3.0% Mn;
0.025% or less P;
0.010% or less S;
0.005 to 0.10% Al;
0.01% or less O (oxygen);
3.0% or less Cr;
3.0% or less Mo; and
0.05 to 0.3% V,
wherein the Cr and Mo content satisfies the relationship: Cr+3Mo≧2.7%, with the balance being Fe and impurities, and the number of nonmetallic inclusions whose major axis is 10 μm or more is within 10 pieces per square millimeter.

7. The low alloy steel for oil country tubular goods according to claim 6, further comprising, at least one element selected from the group consisting by mass % of:
0.0003 to 0.003% B,
0.002 to 0.1% Nb,
0.002 to 0.1% Ti,
0.002 to 0.1% Zr, and
0.003 to 0.03% N.

8. The low alloy steel for oil country tubular goods according to claim 6, further comprising 0.0003 to 0.01% Ca by mass %.

9. The low alloy steel for oil country tubular goods according to claim 7, further comprising 0.0003 to 0.01% Ca by mass %.

10. A seamless steel pipe comprising the steel according to claim 1.

11. A seamless steel pipe comprising the steel according to claim 5.

12. The low alloy steel for oil country tubular goods according to claim 2, further comprising 0.0003 to 0.01% Ca by mass %.

13. The low alloy steel for oil country tubular goods according to claim 3, further comprising 0.0003 to 0.01% Ca by mass %.

14. The low alloy steel for oil country tubular goods according to claim 4, further comprising 0.0003 to 0.01% Ca by mass %.

15. A seamless steel pipe comprising the steel according to claim 2.

16. A seamless steel pipe comprising the steel according to claim 3.

17. A seamless steel pipe comprising the steel according to claim 4.

18. A seamless steel pipe comprising the steel according to claim 6.

19. A seamless steel pipe comprising the steel according to claim 7.

20. A seamless steel pipe comprising the steel according to claim 8.

21. A seamless steel pipe comprising the steel according to claim 9.
